(19) United States
(12) Patent Application Publication
(10) Pub. No.: US 2003/0140547 A1
(43) Pub. Date: Jul. 31, 2003

(54) Wind powered reflecting pest control

(76) Inventor: Rudolph Peterson, Baltimore, MD (US)

Correspondence Address: Robin John Pecora, PA, 204 E. Preston Street, Baltimore, MD, 21202, US

(21) Appl. No.: 10/056,185

(22) Filed: Jan. 28, 2002

(51) Int. Cl. A01M 1/00

(52) U.S. Cl. 43/1

(57) ABSTRACT

A wind powered reflecting pest control (10) having an outer rim (12) which has an outer rim front (12F) and outer rim back (12B). An inner rim (14) is circumferentially attached at an outer edge to an inner edge of the outer rim (12). A plate (16) circumferentially attached at an outer edge to an inner edge of the inner rim (14). The plate (16) is manufactured on at least one side from a reflective material. A holder (20) is securely attached to the top upper center of the outer rim (12).

### BACKGROUND OF THE INVENTION

1. Field of the Invention

The present invention relates to wind powered reflecting pest control. More particularly, the present invention relates to wind powered reflecting pest control having at least one reflective surface which is also capable of emitting sounds to ward off unwanted pests.

2. Related Documents and Patents

This patent application is a continuation of Disclosure Document Number 467530, by inventor Rudolph Peterson, Titled, Environmentally Safe Pest Control, filed with the United States Patent and Trademark Office on Jan. 14, 2000.

3. Description of the Prior Art

Numerous innovations for pest deterrents have been provided in the prior art that are described as follows. Even though these innovations may be suitable for the specific individual purposes to which they address, they differ from the present invention as hereinafter contrasted.

In U.S. Pat. No. 6,176,047, by inventor, Morningstar, titled, Bird deterring device, a bird deterring device is provided for deterring birds away from a body of water. The device includes a hollow body shaped to resemble a crocodile floating in a body water. The body includes a plurality of hollow sections having floats mounted therein for floating the device on the body of water. A pair of reflectors are mounted on the body to resemble eyes. A weight tethered to a bottom side of the body anchors the body and prevents it from flipping over in the water.

In U.S. Pat. No. 5,939,987, by inventor, Cram titled, Roadside deer warning method and system, a warning system to motorists to notify them of the presence of deer or other large animals along a roadside, such that the motorists can slow down and drive cautiously to avoid an accident with the deer. The system includes a plurality of posts installed along the roadside, with each post having a motion detector for sensing the presence of deer. Each motion detector is operatively connected to a light which is activated when a deer enters the sensing zone of the motion detector. The lights and motion detectors may be connected to a 120 volt power supply or to a battery which is coupled to a solar panel for recharging. The lights may be electrically connected in series such that all the lights are illuminated when one motion detector senses a deer. Each motion detector may also be connected to a sound generating device to deter the deer from the roadside. A light-sensitive photoelectric eye may also be provided such that the devices are functional only at night.

In U.S. Pat. No. D 166,334, by inventor, Moon, titled, Combined Bird Perch and Mirror, a device for training a bird to talk including a sound recording playback unit mounted in a housing and with a pivotal perch operative to turn on the playback unit to play the spoken sounds when the bird alights on the perch. The housing has a mirror that is of sufficient size to reveal substantially a full size reflection and the speaker of the unit is mounted directly behind the mirror to encourage the bird on the perch to talk. Holding means are provided in the form of a strip means having notches to latch the perch operated switch in either the “on” or “off” position. The record means for the playback unit includes an endless band with guiding means positioned adjacent the outer periphery of the housing and the tape head of the unit and at least one of the guiding means are resiliently mounted by springs having different strengths.

In U.S. Pat. No. 2,731,949, by inventor, Arnould, titled, Parakeet Mirror Perch, bird perches and more particularly to a wall bracket wall perch that may be flush-mounted against a vertical wall.

In U.S. Pat. No. 1,887,869, by inventor, Clampitt, titled, Bird Cage, a bird cage and the principal objects of my invention are, to provide a bird cage having a revolving member that includes perches that are offset relative to the axis of the revolving member so that the weight* of a bird on the perches will cause the revolving member to operate and further to arrange in the rear portion of the cage a mirror or reflecting member and which latter io will reflect the revolving member and the bird or birds that rest on the perches thereof.

The patented inventions differ from the present invention because the patented inventions lack one or more of the following features: single or double sided mirror, swivel connected on a bottom to a top of the mirror, and transparent line connected to a top of the swivel and securely affixed at a distal end.

Numerous innovations for pest deterrents have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to wind powered reflecting pest control. More particularly, the present invention relates to wind powered reflecting pest control having at least one reflective surface which is also capable of emitting sounds to ward off unwanted pests.

The types of problems encountered in the prior art are pest deterrents are too complicated and costly.

In the prior art, unsuccessful attempts to solve this problem were attempted namely: sound, animated figures, fencing, decoys, and movement activated lights. However, the problem was solved by the present invention because it incorporated the main principals of pest deterrents into one simple inexpensive device.

Innovations within the prior art are rapidly being exploited in the field of pest deterrents.

The present invention went contrary to the teaching of the art which describes and claims devices having sound, animated figures, fencing, decoys, and movement activated lights.

The present invention solved a long felt need for an inexpensive and easy to install pest deterrent.

A synergistic effect was produced utilizing the present invention due to the following facts and results from experimentation: beneficial insects were attracted to gardens by the device which increased crop production while deterring other pests.

Accordingly, it is an object of the present invention to provide a wind powered reflecting pest control having an outer rim, inner rim, plate, swivel, and holder.

More particularly, it is an object of the present invention to provide the outer rim having an outer rim opening, reflective outer rim front, and reflective outer rim back.

In keeping with these objects, and with others which will become apparent hereinafter, one feature of the present invention resides, briefly stated, in the inner rim having a reflective inner rim front and inner rim back.

When the plate is designed in accordance with the present invention, it has a reflective plate front and plate back.

In accordance with another feature of the present invention, the swivel has a swivel clip, swivel barrel, and swivel loop.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### LIST OF REFERENCE NUMERALS UTILIZED IN THE DRAWINGS

10—wind powered reflecting pest control (10)

12—outer rim (12)

12F—outer rim front (12F)

12B—outer rim back (12B)

14—inner rim (14)

14F—inner rim front (14F)

14B—inner rim back (14B)

16—plate (16)

16F—plate front (16F)

16B—plate back (16B)

18—swivel (18)

18A—swivel clip (18A)

18B—swivel barrel (18B)

18C—swivel loop (18C)

20—holder (20)

### BRIEF DESCRIPTION OF THE DRAWINGS

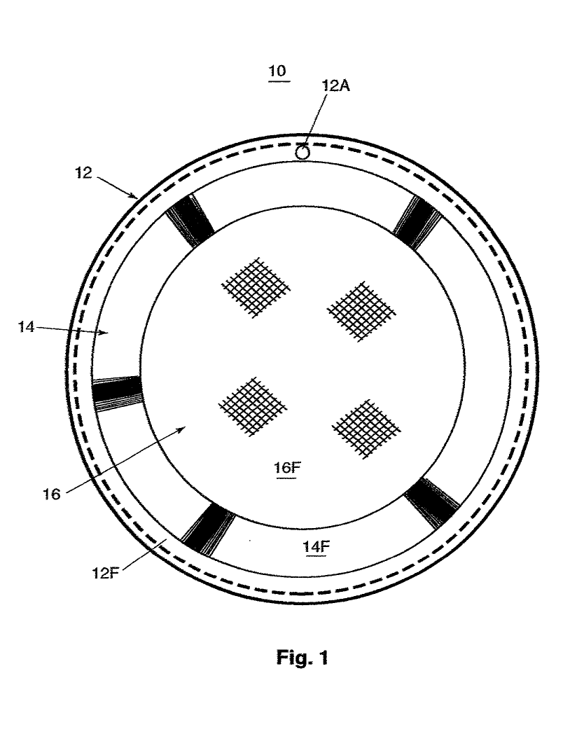

FIG. 1 is a front view of a wind powered reflecting pest control (10).

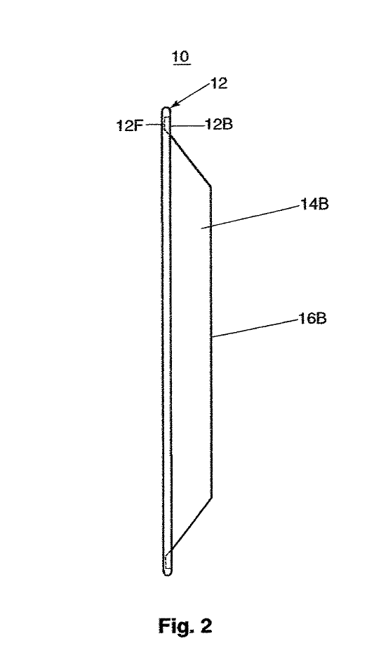

FIG. 2 is a side view of a wind powered reflecting pest control (10).

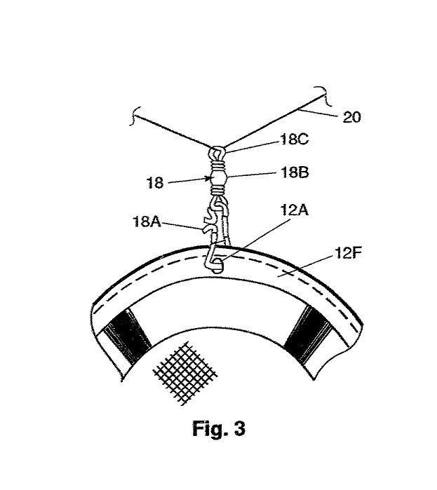

FIG. 3 is a partial front view of a wind powered reflecting pest control (10).

### DESCRIPTION OF THE PREFERRED EMBODIMENT

Referring to FIG. 1 which is a front view of a wind powered reflecting pest control (10) comprising an outer rim (12) which comprises an outer rim front (12F) and outer rim back (12B). Preferably, the outer rim (12) further comprises an outer rim opening (12A) through the top upper center thereof, the holder (20) is securely positioned through the outer rim opening (12A). The outer rim front (12F) is manufactured from a reflective material. The outer rim back (12B) is preferably manufactured from a reflective material. The outer rim (12) is manufactured from a convex or concave reflective material which functions to increase reflectivity. The outer rim (12) convex or concave reflective material has a three dimensional configuration selected from a group consisting of round, oval, square, rectangle, pentagonal, hexagonal, octagonal, and diamond.

The wind powered reflecting pest control (10) further comprises an inner rim (14) circumferentially attached at an outer edge to an inner edge of the outer rim (12), the inner rim (14) comprises an inner rim front (14F) and inner rim back (14B). An angle of attachment between the inner rim (14) circumferentially attached at the outer edge to the inner edge of the outer rim (12) is selected from a group consisting of planer, acute, and obtuse (preferable). (refer to FIG. 2) The inner rim front (14F) is preferably manufactured from a reflective material. The inner rim back (14B) is also preferably manufactured from a reflective material. The inner rim (14) is manufactured from a convex or concave reflective material functioning to increase reflectivity. The inner rim (14) convex or concave reflective material has a three dimensional configuration selected from a group consisting of round, oval, square, rectangle, pentagonal, hexagonal, octagonal, and diamond.

The wind powered reflecting pest control (10) further comprises a plate (16) circumferentially attached at an outer edge to an inner edge of the inner rim (14). The plate (16) comprises a plate front (16F) and a plate back (16B). The plate (16) is manufactured on al least one side from a reflective material. The plate front (16F) is preferably manufactured from a reflective material. The plate back (16B) is also preferably manufactured from a reflective material. The plate (16) is manufactured from a convex or concave reflective material functioning to increase reflectivity. The plate (16) convex or concave reflective material has a three dimensional configuration selected from a group consisting of round, oval, square, rectangle, pentagonal, hexagonal, octagonal, and diamond. An angle of attachment between the inner rim (14) circumferentially attached at the inner edge to the outer edge of the plate (16) is selected from a group consisting of planer, obtuse (preferable), and acute. (refer to FIG. 2)

The wind powered reflecting pest control (10) further comprises a holder (20) securely attached to the top upper center of the outer rim (12).

Referring to FIG. 3 which is a partial front view of a wind powered reflecting pest control (10). The wind powered reflecting pest control (10) preferably further comprises a swivel (18) securely attached at one distal end to the top center of the outer rim (12) and securely attached at and opposite distal end to the holder (20). The swivel (18) comprises a swivel clip (18A) connected to a swivel loop (18C) by a swivel barrel (18B), the swivel clip (18A) is securely positioned through the outer rim opening (12A), and the holder (20) is securely attached to the swivel loop (18C). The swivel (18) is manufactured from a non-corroding material selected from a group consisting of stainless steel, brass, copper, plastic, plastic composite, and metal composite.

The wind powered reflecting pest control (10) is manufactured from a material selected from a group consisting of glass, glass composite, plastic, plastic composite, rubber, rubber composite, fiberglass, fiberglass composite, epoxy, epoxy composite, metal and metal composite.

It will be understood that each of the elements described above, or two or more together, may also find a useful application in other types of constructions differing from the type described above.

While the invention has been illustrated and described as embodied in a pest deterrent, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A wind powered reflecting pest control (10) comprising:
A) an outer rim (12) which comprises an outer rim front (12F) and outer rim back (12B);
B) an inner rim (14) circumferentially attached at an outer edge to an inner edge of the outer rim (12), the inner rim (14) comprises an inner rim front (14F) and inner rim back (14B);
C) a plate (16) circumferentially attached at an outer edge to an inner edge of the inner rim (14), the plate (16) comprises a plate front (16F) and a plate back (16B), the plate (16) is manufactured on al least one side from a reflective material; and
D) a holder (20) securely attached to the top upper center of the outer rim (12).

2. The wind powered reflecting pest control (10) as described in claim 1, wherein the outer rim (12) further comprises an outer rim opening (12A) through the top upper center thereof, the holder (20) is securely positioned through the outer rim opening (12A).

3. The wind powered reflecting pest control (10) as described in claim 1, wherein the outer rim front (12F) is manufactured from a reflective material.

4. The wind powered reflecting pest control (10) as described in claim 3, wherein the outer rim back (12B) is manufactured from a reflective material.

5. The wind powered reflecting pest control (10) as described in claim 1, wherein the outer rim (12) is manufactured from a convex or concave reflective material.

6. The wind powered reflecting pest control (10) as described in claim 5, wherein the outer rim (12) convex or concave reflective material has a three dimensional configuration selected from a group consisting of round, oval, square, rectangle, pentagonal, hexagonal, octagonal, and diamond.

7. The wind powered reflecting pest control (10) as described in claim 1, wherein an angle of attachment between the inner rim (14) circumferentially attached at the outer edge to the inner edge of the outer rim (12) is selected from a group consisting of planer, acute, and obtuse.

8. The wind powered reflecting pest control (10) as described in claim 1, wherein the inner rim front (14F) is manufactured from a reflective material.

9. The wind powered reflecting pest control (10) as described in claim 8, wherein the inner rim back (14B) is manufactured from a reflective material.

10. The wind powered reflecting pest control (10) as described in claim 1, wherein the inner rim (14) is manufactured from a convex or concave reflective material.

11. The wind powered reflecting pest control (10) as described in claim 10, wherein the inner rim (14) convex or concave reflective material has a three dimensional configuration selected from a group consisting of round, oval, square, rectangle, pentagonal, hexagonal, octagonal, and diamond.

12. The wind powered reflecting pest control (10) as described in claim 1, wherein the plate front (16F) is manufactured from a reflective material.

13. The wind powered reflecting pest control (10) as described in claim 12, wherein the plate back (16B) is manufactured from a reflective material.

14. The wind powered reflecting pest control (10) as described in claim 1, wherein the plate (16) is manufactured from a convex or concave reflective material.

15. The wind powered reflecting pest control (10) as described in claim 14, wherein the plate (16) convex or concave reflective material has a three dimensional configuration selected from a group consisting of round, oval, square, rectangle, pentagonal, hexagonal, octagonal, and diamond.

16. The wind powered reflecting pest control (10) as described in claim 1, wherein an angle of attachment between the inner rim (14) circumferentially attached at the inner edge to the outer edge of the plate (16) is selected from a group consisting of planer, obtuse, and acute.

17. The wind powered reflecting pest control (10) as described in claim 1, is manufactured from a material selected from a group consisting of glass, glass composite, plastic, plastic composite, rubber, rubber composite, fiberglass, fiberglass composite, epoxy, epoxy composite, metal and metal composite.

18. The wind powered reflecting pest control (10) as described in claim 1, further comprises a swivel (18) securely attached at one distal end to the top center of the outer rim (12) and securely attached at and opposite distal end to the holder (20).

19. The wind powered reflecting pest control (10) as described in claim 18, wherein the swivel (18) comprises a swivel clip (18A) connected to a swivel loop (18C) by a swivel barrel (18B), the swivel clip (18A) is securely positioned through the outer rim opening (12A), and the holder (20) is securely attached to the swivel loop (18C).

20. The wind powered reflecting pest control (10) as described in claim 19, wherein the swivel (18) is manufactured from a non-corroding material selected from a group consisting of stainless steel, brass, copper, plastic, plastic composite, and metal composite.
